(19) United States
(12) Patent Application Publication
(10) Pub. No.: US 2026/0154644 A1
(43) Pub. Date: Jun. 4, 2026

(54) System and Method for Artificial Intelligence-Driven Optimization of Group Notifications in Social Goal Accountability Platforms

(71) Applicants: Tyler Patterson, Fairview, UT (US); Sarai Patterson, Fairview, UT (US); Jesse Wade, Fairview, UT (US)

(72) Inventors: Tyler Patterson, Fairview, UT (US); Sarai Patterson, Fairview, UT (US); Jesse Wade, Fairview, UT (US)

(21) Appl. No.: 18/967,673

(22) Filed: Dec. 4, 2024

(51) Int. Cl. G06Q 10/0637; H04L 67/55

(52) U.S. Cl. CPC G06Q 10/0637; H04L 67/55

(57) ABSTRACT

The present invention provides a system and method for optimizing group-based goal accountability through the integration of artificial intelligence (AI). The invention utilizes a digital platform where users set personal goals, form accountability groups, and track progress. An AI engine dynamically analyzes user behavior, goal completion patterns, and group interactions to generate tailored notifications that are strategically timed and contextually relevant. These notifications are designed to enhance engagement, encourage peer-to-peer support, and address challenges effectively. The system further includes adaptive goal coaching features, leveraging machine learning to provide personalized recommendations for refining goals based on performance data. Progress visualization tools display individual and group achievements, reinforcing motivation and accountability. The invention is applicable across diverse domains, including personal development, workplace productivity, education, and clinical settings, offering a scalable solution for fostering sustained progress and collaboration within group environments.

### BACKGROUND OF THE INVENTION

### Field of Invention

The present invention pertains to the field of social accountability systems and methods, with particular application to platforms designed for goal setting, progress tracking, and user engagement within group environments. More specifically, the invention relates to a novel integration of artificial intelligence (AI) and machine learning techniques to enhance the functionality, efficiency, and effectiveness of group-based notifications and interactions. By dynamically analyzing user behavior, progress metrics, and group dynamics, the invention optimizes the timing, content, and delivery of notifications, thereby fostering improved engagement, accountability, and success in achieving personal and collective goals. The invention further encompasses the use of AI-driven strategies to identify challenges, provide tailored support, and maximize motivational impact within social accountability frameworks.

### Brief Summary of the Invention

The present invention provides a system and method that leverages artificial intelligence (AI) to enhance the functionality and effectiveness of group-based social accountability platforms. The invention is designed to optimize the delivery of notifications and interactions among group members in goal-setting environments, thereby promoting individual progress and group cohesion.

Using AI and machine learning algorithms, the system analyzes user behavior, performance data, and group dynamics to generate intelligent notifications that are contextually relevant and strategically timed. These notifications serve to inform group members of individual and collective progress, highlight challenges, and encourage supportive interactions. The system further tailors its notifications based on historical data and predictive modeling to maximize motivational impact and engagement.

The invention is adaptable across various applications, including personal development, workplace productivity, educational environments, and clinical settings. By automating and refining group communication strategies, the invention addresses common barriers to goal achievement, such as inconsistent participation and lack of sustained motivation, while fostering a collaborative and supportive environment.

### BRIEF DESCRIPTION OF THE FIGURES

FIG. 1: Illustrates how the system leverages artificial intelligence to guide users through a seamless process of setting goals, forming groups, tracking progress, and dynamically optimizing notifications and group interactions to foster sustained engagement and goal achievement.

FIG. 2: Each person in a group is provided with a real-time view of the progress of other group members, while the system dynamically encourages individuals to support and celebrate each other's achievements through AI-driven prompts.

### DETAILED DESCRIPTION

The present invention provides a system and method for enhancing group-based goal-setting and accountability platforms through the integration of artificial intelligence (AI). This invention addresses key challenges in maintaining engagement, fostering collaboration, and ensuring consistent progress in achieving individual and collective goals. By utilizing advanced AI and machine learning algorithms, the system dynamically optimizes notifications and interactions among users, making them contextually relevant, strategically timed, and highly effective.

The invention is implemented within a digital platform, such as a mobile or web application, where users can register, set goals, and form or join groups for mutual accountability. Users are guided through a structured process of selecting achievable and meaningful goals, reporting on their progress, and interacting with other group members to provide and receive support. The AI component of the system continuously analyzes user data, including behavior patterns, goal achievement rates, and group interactions. This analysis allows the system to tailor its functions to individual and group needs, thereby enhancing engagement and improving outcomes.

A central feature of the invention is its ability to generate optimized notifications. These notifications are designed to foster group dynamics and individual accountability. For instance, the system may notify group members when a particular individual is excelling, struggling, or missing progress reports. Notifications are customized to the recipient based on historical data and predictive modeling, ensuring they are relevant and likely to elicit positive responses. By leveraging the power of peer support, the system encourages users to motivate and celebrate one another, creating a collaborative environment that reinforces commitment to goals.

The AI component also supports users in setting and refining goals. During the goal-setting process, the system analyzes historical performance and user preferences to provide actionable recommendations. If a user consistently struggles with a specific goal, the system may suggest adjustments to make the goal more achievable without diminishing its meaningfulness. Similarly, if a user consistently exceeds expectations, the system may propose more challenging objectives to maintain engagement. This adaptive coaching ensures that users remain motivated and aligned with their capabilities.

Another important aspect of the invention is its ability to visualize progress in ways that enhance motivation and accountability. The system generates dashboards that display individual and group achievements, highlight milestones, and track trends over time. For example, a user might see their progress streaks or a summary of the group's collective accomplishments. This visualization reinforces the value of consistent effort and promotes a sense of shared success.

The workflow of the system begins with an initial setup phase, where users register, define their goals, and join groups. The AI immediately starts analyzing user inputs to develop a strategy for engagement, including determining the optimal timing and content of notifications. As users report on their progress, either manually or through automated inputs (e.g., wearable devices), the system continuously refines its strategies based on emerging patterns. Notifications are then sent to prompt users to take action, such as encouraging a struggling member, celebrating milestones, or reminding a user to report on their goals.

At the end of each goal cycle, which may be weekly or follow another defined cadence, the system generates a comprehensive summary of individual and group performance. This summary serves as the basis for a goal review process, where users are guided by the AI to evaluate their progress and make adjustments. Over time, the AI refines its recommendations and notification strategies, ensuring that the system evolves to meet the changing needs of its users.

The invention is particularly well-suited for a wide range of applications, including personal development, workplace productivity, education, and clinical interventions. In personal development, the system helps individuals stay motivated and achieve self-improvement goals, such as fitness or mental health objectives. In workplaces, it supports team productivity and collaboration by encouraging employees to meet shared goals. In educational settings, the system enhances student engagement and performance. In clinical environments, it assists patients in adhering to treatment plans or overcoming challenges like addiction.

For example, consider a user named Amanda, who joins a group to improve fitness habits. Amanda sets a goal to walk 10,000 steps daily. Over the first week, the AI observes that Amanda consistently reports progress during weekdays but misses her weekend goals. In response, the system sends a notification to the group, prompting them to encourage Amanda with a supportive message. Simultaneously, it recommends that Amanda adjust her goal to include a rest day on Sundays. The system also highlights Amanda's weekday streak in the group dashboard, boosting morale and reinforcing positive behaviors. Through these interactions, the invention ensures that Amanda remains engaged and supported while fostering a collaborative environment within her group.

Overall, this invention represents a significant advancement in social goal accountability platforms by integrating artificial intelligence to dynamically optimize user interactions and engagement. By addressing common challenges such as inconsistent participation, lack of motivation, and poor communication, the invention fosters sustained progress and collaboration, improving outcomes for users across a variety of domains.

Below is a simplified outline of the app's key components with code snippets in Python for the backend (using Flask) and pseudocode for the AI and notification system.

### Backend (Flask)

from flask import Flask, request, jsonify
from datetime import datetime
import random
app=Flask(__name__)
#Simulated database
users={}
groups={}
notifications={}
#Add a new user
@app.route(‘/add_user’, methods=[‘POST’])
def add_user( ):
   data=request.json
   user_id=len(users)+1
   users[user_id]={
      “name”: data[“name”],
      “goals”: [],
      “progress”: [],
      “group_id”: None
}
return jsonify({“message”: “User added”, “user_id”: user_id})
#Create a group
@app.route(‘/create_group’, methods=[‘POST’])
def create_group( ):
   data=request.json
   group_id=len(groups)+1
   groups[group_id]={
      “name”: data[“name”],
      “members”: [],
      “notifications”: []
}
return jsonify({“message”: “Group created”, “group_id”: group_id})
#Add user to a group
@app.route(‘/add_to_group’, methods=[‘POST’])
def add_to_group( ):
data=request.json
user_id=data[“user_id”]
group_id=data[“group_id”]
if user_id in users and group_id in groups:
   users[user_id][“group_id”]=group_id
   groups[group_id][“members”].append(user_id)
   return jsonify({“message”: “User added to group”})
return jsonify({“error”: “Invalid user or group ID”}), 400
#Submit progress
@app.route(‘/submit_progress’, methods=[‘POST’])
def submit_progress( ):
   data=request.json
   user_id=data[“user_id”]
   progress=data[“progress”]
if user_id in users:
   users[user_id][“progress”].append({
      “date”: datetime.now( ).strftime(“%Y-%m-%d”),
      “progress”: progress
   })
   return jsonify({“message”: “Progress submitted”})
return jsonify({“error”: “Invalid user ID”}), 400
#Get group notifications
@app.route(‘/group_notifications/<int:group_id>’, methods=[‘GET’])
def group_notifications(group_id):
   if group_id in groups:
      return jsonify(groups[group_id][“notifications”])
   return jsonify({“error”: “Group not found”}), 404
if __name__==“__main__”:
   app.run(debug=True)

### Artificial Intelligence Module

Objective: Optimize notifications by analyzing user behavior and group dynamics. This can be implemented using a machine learning model.
from sklearn.ensemble import RandomForestClassifier
import numpy as np
import pandas as pd
#Example: Train an AI model to predict the best notification time
def train_notification_model( ):
   #Simulated data: [user_id, time_of_day, engagement_score]
   data=pd.DataFrame({
      “user_id”: [1, 2, 1, 2, 1],
      “time_of_day”: [9, 14, 18, 10, 20],
      “engagement_score”: [1, 0, 1, 1, 0 ] #1=Engaged, 0=Ignored
})
X=data[[“user_id”, “time_of_day”]]
y=data[“engagement_score”]
model=RandomForestClassifier( )
model.fit(X, y)
return model
def predict_best_time(user_id):
   model=train_notification_model( )
   times=np.array([[user_id, hour] for hour in range(24)])
   predictions=model.predict(times)
   best_time=times[np.argmax(predictions), 1]
   return best_time

### Frontend Outline

Framework: React.js or Flutter for mobile apps.
Features: User registration, group dashboards, daily progress submission, and notifications.
API Integration: Communicate with the Flask backend using RESTful APIs.

### DETAILED DESCRIPTION OF FIGURES

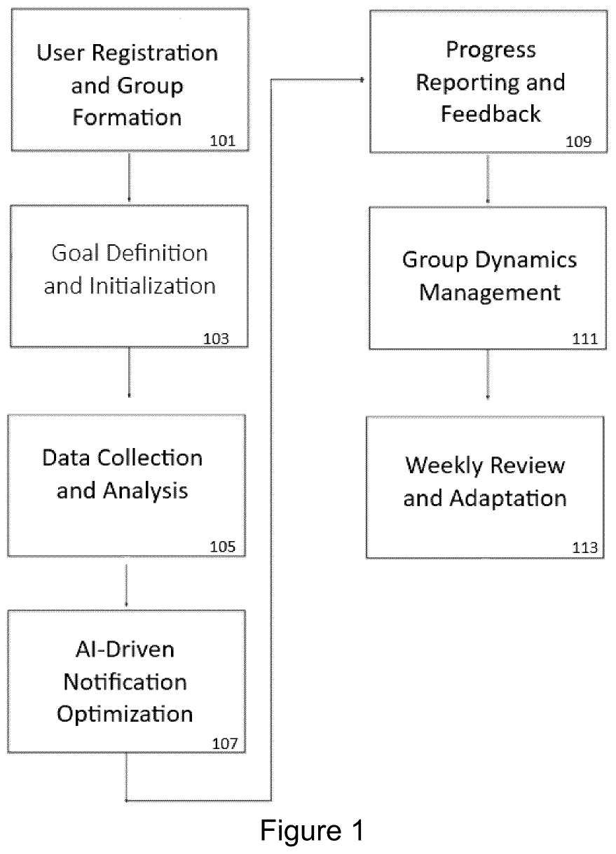

FIG. 1.101: User Registration and Group Formation-In this initial step, users create accounts on the platform by providing basic information and agreeing to platform terms. The system facilitates group formation by allowing users to join existing groups or create new ones, inviting members through integrated communication channels such as email or in-app messaging. Group settings, including size, shared objectives, and communication preferences, are established during this step.

FIG. 1.103: Goal Definition and Initialization-Users define their personal goals by selecting actionable and measurable objectives tailored to their needs. The system employs an AI-driven goal coaching module to guide users in setting achievable and meaningful goals based on their past behavior and preferences. Each goal is associated with a time-bound cycle, such as a weekly schedule, to structure progress tracking and evaluation.

FIG. 1.105: Data Collection and Analysis-The system collects data continuously from user interactions, including goal progress updates, reporting patterns, and group activities. Additional data may include inputs from connected devices (e.g., fitness trackers). The AI module analyzes this data to identify trends, user behaviors, and group dynamics, creating a comprehensive dataset to inform subsequent steps in the process.

FIG. 1.107: AI-Driven Notification Optimization-Leveraging the insights generated in the analysis step, the AI module predicts the optimal timing, content, and delivery methods for notifications. Notifications may include reminders, motivational messages, or peer encouragement prompts, tailored to maximize user engagement and promote group accountability. The AI continuously updates its models based on user responses, refining its strategies over time.

FIG. 1.109: Progress Reporting and Feedback-Users report their daily progress through a simple interface, either manually or via automated inputs. The system provides real-time feedback, including visual progress indicators and celebratory messages for achievements. It also tracks missed reports and alerts users or group members as needed to maintain accountability.

FIG. 1.111: Group Dynamics Management-The platform prioritizes peer-to-peer interactions by notifying group members about significant milestones or challenges within the group. For example, if a user is struggling, the system may prompt other members to send encouragement. Positive reinforcement mechanisms, such as recognition for streaks or group achievements, are implemented to strengthen group cohesion.

FIG. 1.113: Weekly Review and Adaptation-At the end of each cycle, the system generates detailed summaries of individual and group performance. Users are prompted to review their goals and make adjustments based on the AI's recommendations. The system resets for the next cycle, incorporating learned insights to optimize engagement and effectiveness in future iterations.

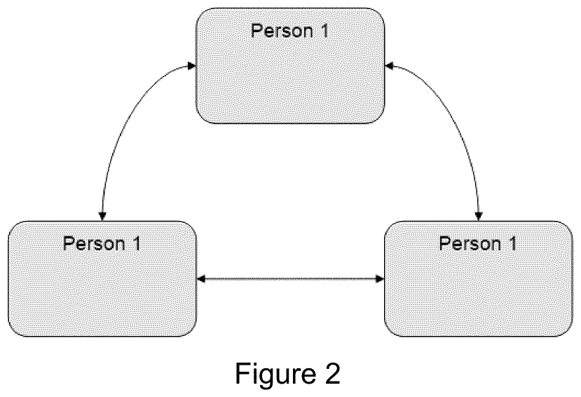

FIG. 2: The system enables each user in a group to access a shared progress dashboard that visualizes individual and collective achievements. This dashboard is updated in real-time to reflect daily reports, milestone completions, and overall goal progress. The platform uses artificial intelligence to analyze group dynamics and identify opportunities for interaction. For instance, if a member has achieved a significant milestone, such as a multi-day streak or surpassing a set goal, the system generates prompts encouraging others to send celebratory messages or acknowledgments. Conversely, if a member appears to be struggling or falling behind, the system may notify other group members, suggesting personalized messages of encouragement or support.

To enhance engagement, the system employs gamification elements, such as group-level rewards or leaderboards, which are visible to all members. The system comprises an application-specific integrated circuit (ASIC) for an artificial neural network connected to a communications network, the ASIC comprising: a plurality of neurons organized in an array, wherein each neuron comprises a register, a processing element and at least one input, and a plurality of synaptic circuits, each synaptic circuit including a memory for storing a synaptic weight, wherein each neuron is connected to at least one other neuron via one of the plurality of synaptic circuits configured to execute AI algorithms dynamically adjusting notifications based on the group's overall activity and interaction patterns, ensuring that prompts for encouragement or celebration are neither excessive nor intrusive. This functionality fosters a sense of camaraderie and mutual accountability, strengthening the group's collective motivation and improving the likelihood of individual and group success. The system also provides the flexibility for users to customize how and when they receive these notifications, catering to individual preferences and maintaining an optimal balance of interaction.

What is claimed is:

1. A system for optimizing group-based goal accountability using artificial intelligence, comprising:
a. A digital platform configured to facilitate user registration, group formation, and goal-setting activities;
b. A data collection module that gathers user-specific information, including goal progress, reporting patterns, and group interactions;
c. application-specific integrated circuit (ASIC) for an artificial neural network connected to a communications network, the ASIC comprising: a plurality of neurons organized in an array, wherein each neuron comprises a register, a processing element and at least one input, and a plurality of synaptic circuits, each synaptic circuit including a memory for storing a synaptic weight, wherein each neuron is connected to at least one other neuron via one of the plurality of synaptic circuits configured to execute AI algorithms dynamically adjusting notifications based on the group's overall activity and interaction patterns and configured to:
i. Analyze user data and group dynamics to identify engagement patterns;
ii. Predict optimal notification timing and content for individual users and groups;
iii. Generate contextually relevant notifications to enhance user engagement and group cohesion;
d. A notification delivery module configured to send customized notifications to users based on predictions made by the artificial intelligence engine;
e. A progress visualization module that displays individual and group achievements, trends, and milestones to promote accountability and motivation.

2. A method for optimizing notifications in group-based goal accountability systems, comprising the steps of:
a. Collecting data on user behavior, goal completion, and group interactions within a digital platform;
b. Analyzing the collected data using an artificial intelligence engine to identify trends, challenges, and opportunities for engagement;
c. Predicting optimal notification timing and tailoring notification content based on individual and group-specific factors;
d. Delivering the notifications to users through a notification delivery module;
e. Updating the artificial intelligence engine's predictive model based on user responses to notifications and goal progress.

3. A system for adaptive goal coaching using artificial intelligence in a group accountability platform, comprising:
a. A digital platform enabling users to define personal goals and report on their progress;
b. A machine learning engine configured to:
i. Analyze user progress data to identify patterns of success and challenges;
ii. Provide tailored recommendations for adjusting goals to maintain engagement and motivation;
c. A notification system that informs group members about individual and collective progress and encourages supportive interactions;
d. A progress tracking module that visualizes user and group performance metrics to reinforce goal accountability.

4. The system of claim 1, wherein the artificial intelligence engine incorporates machine learning models trained on historical user behavior and engagement patterns.

5. The system of claim 1, wherein the notification delivery module uses multi-channel communication, including in-app messages, emails, and push notifications.

6. The method of claim 2, further comprising the step of periodically generating group performance summaries to provide feedback and encourage collaborative goal setting.

7. The method of claim 2, wherein the artificial intelligence engine identifies inactive users and generates notifications prompting group members to provide personalized encouragement.

8. The system of claim 3, wherein the machine learning engine dynamically adjusts its recommendations based on real-time feedback from users.

9. The system of claim 3, wherein the progress tracking module highlights streaks and milestone achievements to reinforce user motivation.

10. The system of claim 1, wherein the notification delivery module prioritizes peer-to-peer encouragement over automated system-generated reminders.
